(19) United States
(12) Patent Application Publication
(10) Pub. No.: US 2014/0305305 A1
(43) Pub. Date: Oct. 16, 2014

(54) AIR CLEANER AND PILL DISPENSER WITH AIR CLEANER

(71) Applicant: HON HAI PRECISION INDUSTRY CO., LTD., New Taipei (TW)

(72) Inventors: PAO-HENG SHEN, New Taipei (TW); SZU-HAI HUANG, New Taipei (TW)

(73) Assignee: HON HAI PRECISION INDUSTRY CO., LTD., New Taipei (TW)

(21) Appl. No.: 14/220,158

(22) Filed: Mar. 20, 2014

(30) Foreign Application Priority Data
Apr. 12, 2013 (TW) 102112994

(51) Int. Cl. B03C 3/30

(52) U.S. Cl. CPC B03C 3/30
USPC 96/17

(57) ABSTRACT

An air cleaner includes a box and a plurality of absorbers. The box includes a base and a top cover covering the base. The base includes a bottom plate opposite to the top cover. The plurality of absorbers are accommodated in the box. Securing ends of the plurality of absorbers are attached to the bottom plate, and free ends of plurality of absorbers touch the top cover. The plurality of absorbers are configured to move with air flowing in the box to rub against the top cover to generate static charges, and dust particles in the air attaches to the static charges. The box outputs air without the dust particles.

### BACKGROUND

1. Technical Field

The present disclosure relates to pill dispensers, and particularly to a pill dispenser with an air cleaner.

2. Description of Related Art

A pill dispenser always includes a plurality of compartments for holding pills. Due to pills rubbing against each other and against walls of the compartments, pill dust may accumulate. This accumulation of pill dust may prevent the pill dispenser from functioning properly. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a pill dispenser in accordance with an embodiment.

FIG. 2 is an exploded, isometric view of an air cleaner of FIG. 1.

FIG. 3 is an assembled view of the air cleaner of FIG. 2.

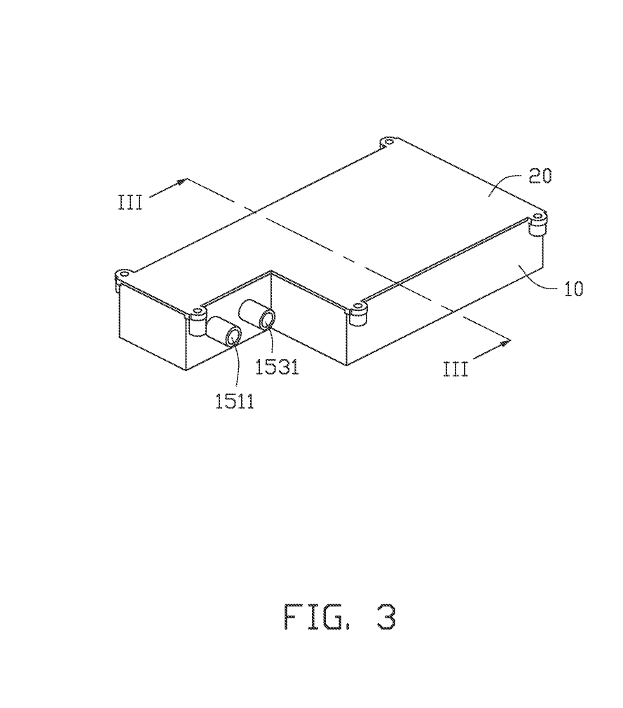

FIG. 4 is a cross-sectional view of the air cleaner taken along a line III-III of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

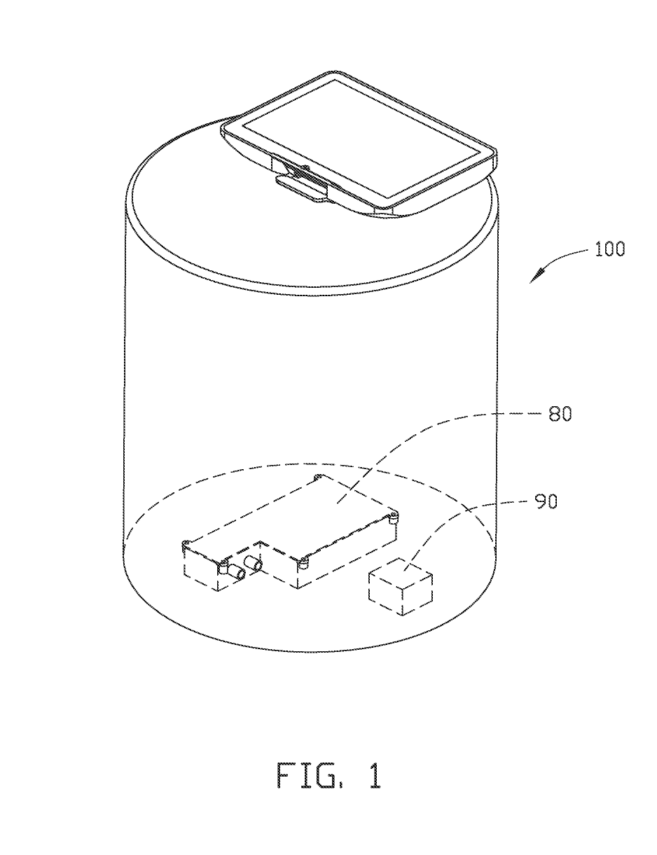

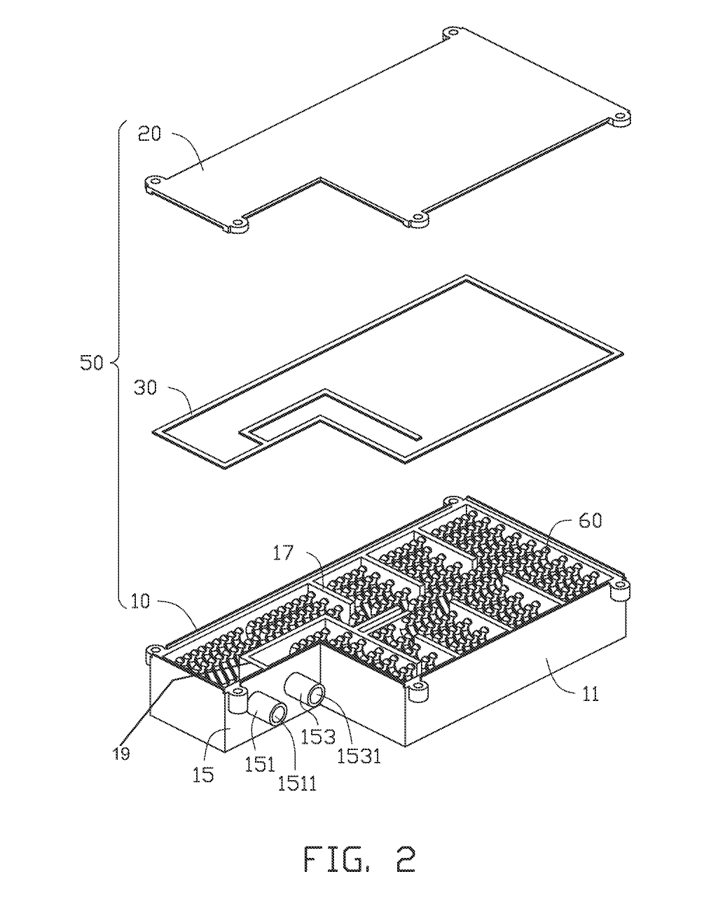

FIGS. 1-2 illustrate an embodiment of a pill dispenser apparatus 100. The pill dispenser apparatus 100 includes an air cleaner 80 and an air pump 90. The air pump 90 can produce air to the air cleaner 80.

The air cleaner 80 can adsorb dust particles from the air and includes a box 50 and a plurality of absorbers 60 accommodated in the box 50. In one embodiment, a diameter of each absorber 60 is about 0.01 mm to 0.1 mm, the box 50 is made of plastic, and the plurality of absorbers 60 are made of floss. In another embodiment, the box is made of glass, and the plurality of absorbers 60 are made of silk.

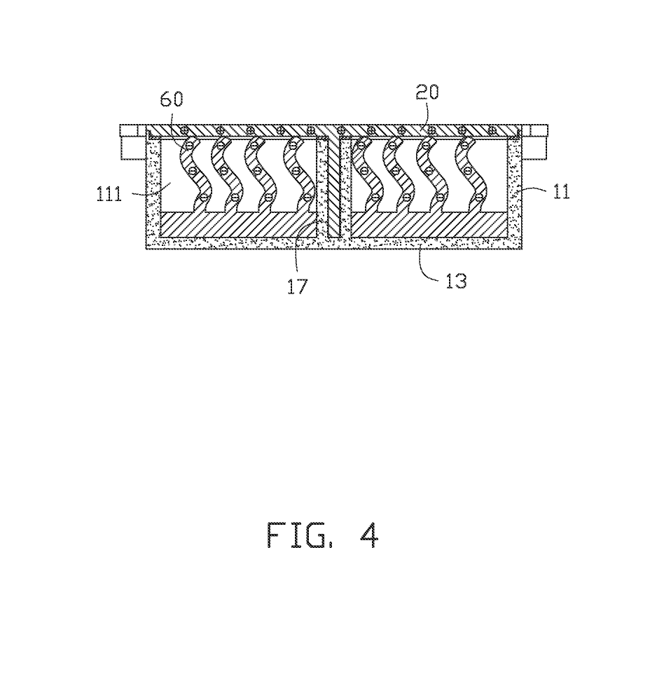

FIG. 4 shows that, the box 50 includes a base 10, a top cover 20, and a sealing member 30. The base 10 includes a bottom plate 13, a plurality of side plates 11, a converting board 15, a plurality of first dividing plates 17, and a second dividing plate 19. The plurality of side plates 11 extend upwards from the bottom plate 13. The converting board 15 extends from the bottom plate 13 and is connected to two adjacent side plates 11, such that the plurality of side plates 11, the converting board 15, and the bottom plate 13 cooperatively define an accommodation space 111 (shown in FIG. 4). A first post 151 and a second post 153 are located on the converting board 15. The first post 151 defines an inlet port 1511 in communication with the accommodation space 11. The first post 151 can be connected with the air pump 90 via an air transferring pipeline (not show). The inlet port 1511 has a first extension direction that is parallel to the bottom plate 13. The second post 153 defines an outlet port 1531 in communication with the accommodation space 11. The outlet port 1531 has a second extension that is parallel to the bottom plate 13. Securing ends of the plurality of absorbers 60 are attached to the bottom plate 13.

The plurality of first dividing plates 17 are respectively connected to two opposite side plates 11 to separate the plurality of absorbers 60 and guide the air. The second dividing plate 19 is connected to the converting board 15 and partially surrounds the outlet port 1531, to prevent the air with dust particles from flowing out of the box 10 through the outlet port 1531. The inlet port 1511 and the outlet port 1531 are located on two opposite sides of the dividing plate 19.

The top cover 20 is installed on the base 10, to cover the accommodation space 111, such that free ends of the plurality of absorbers 60 touch the top cover 20. The sealing member 30 is sandwiched between the top cover 20 and the base 10, to seal the base 10.

In use, the air pump 90 is turned on, and the air pump 90 pulls the ambient air within the pill dispenser 100 and passes it to the inlet port 1511. The air moves the plurality of absorbers 60, and the plurality of absorbers 60 rub against the top cover 20, to generate static charges, and the dust particles in the air attaches to the static charges. Thus air without the dust particles flows out of the box 50 through the outlet port 1531.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An air cleaner comprising:
a box comprising a base and a top cover covering the base, and the base comprising a bottom plate opposite to the top cover; and
a plurality of absorbers accommodated in the box,
wherein securing ends of the plurality of absorbers are attached to the bottom plate, and free ends of the plurality of absorbers touch with the top cover; the plurality of absorbers is configured to move with air flowing in the box and rub against the top cover to generate static charges, and dust particles in the air attaches to the static charges.

2. The air cleaner of claim 1, wherein the base further comprises a plurality of side plates and a converting board, the plurality of side plates, the converting board, and the bottom plate cooperatively define an accommodation space for receiving the plurality of absorbers.

3. The air cleaner of claim 2, wherein the base defines an inlet port and an outlet port in communication with the accommodation space, and the inlet port guides the air into the box, and the outlet port guides the air out of the box.

4. The air cleaner of claim 3, wherein the plurality of side plates and the converting board extend from the bottom plate, each of the plurality of side plates and the converting board are substantially perpendicular to the bottom plate, and the converting board is connected to two adjacent side plates of the plurality of side plates.

5. The air cleaner of claim 3, wherein the inlet port has a first extension direction that is parallel to the bottom plate, and the outlet port has a second extension direction that is parallel to the bottom plate.

6. The air cleaner of claim 3, wherein the base further comprises a plurality of first dividing plates to separate the plurality of absorbers and guide the air, and the plurality of first dividing plates are located on the bottom plate and respectively connected to two of the plurality of side plates, and the two of the plurality of side plates are opposite to each other.

7. The air cleaner of claim 3, wherein the base further comprises a second dividing plate, the second dividing plate is connected to the converting board, and the inlet port and the outlet port are defined on two sides of the second dividing plate.

8. The air cleaner of claim 1, wherein the box is made of plastic, and the plurality of absorbers are made of floss.

9. The air cleaner of claim 1, wherein the box is made of glass, and the plurality of absorbers are made of silk.

10. A pill dispenser apparatus comprising:
an air pump configured to produce air; and
an air cleaner, the air cleaner comprising:
a box connected with the air pump and comprising a base and a top cover covering the base, and the base comprising a bottom plate opposite to the top cover; and
a plurality of absorbers accommodated in the box,
wherein securing ends of the plurality of absorbers are attached to the bottom plate, and free ends of plurality of absorbers touch with the top cover; the plurality of absorbers is configured to move with the air flowing in the box and rub against the top cover to generate static charges, and dust particles in the air attaches to the static charges.

11. The pill dispenser apparatus of claim 10, wherein the base further comprises a plurality of side plates and a converting board, the plurality of side plates, the converting board, and the bottom plate cooperatively define an accommodation space for receiving the plurality of absorbers.

12. The pill dispenser apparatus of claim 11, wherein the base define an inlet port and an outlet port in communication with the accommodation space, the inlet port guides the air into the box, and the outlet port guides the air without the dust particles out of the box.

13. The pill dispenser apparatus of claim 12, wherein the plurality of side plates and the converting board extend from the bottom plate, each of the plurality of side plates and the converting board are substantially perpendicular to the bottom plate, and the converting board is connected to two adjacent side plates of the plurality of side plates.

14. The pill dispenser apparatus of claim 12, wherein the inlet port has a first extension direction that is parallel to the bottom plate, and the outlet port has a second extension direction that is parallel to the bottom plate.

15. The pill dispenser apparatus of claim 12, wherein the base further comprises a plurality of first dividing plates to separate the plurality of absorbers and guide the air, and the plurality of first dividing plates are located on the bottom plate and respectively connected to two of the plurality of side plates, and the two of the plurality of side plates are opposite to each other.

16. The pill dispenser apparatus of claim 12, wherein the base further comprises a second dividing plate, the second dividing plate is connected to the converting board, and the inlet port and the outlet port are disposed on two sides of the second dividing plate.

17. The pill dispenser apparatus of claim 10, wherein the box is made of plastic, and the plurality of absorbers are made of floss.

18. The pill dispenser apparatus of claim 10, wherein the box is made of glass, and the plurality of absorbers are made of silk.
